(19) United States
(12) Patent Application Publication
(10) Pub. No.: US 2017/0104893 A1
(43) Pub. Date: Apr. 13, 2017

(54) SYSTEM AND METHOD OF PIXEL MANIPULATION AND SCREEN DISPLAY DISRUPTION

(71) Applicants: Henry Hardy, Robina (AU); Daniel Moore, Molendinar (AU); David G. Rosenbaum, Highland Park, IL (US); Benjamin D. Rotman, Deerfield, IL (US)

(72) Inventors: Henry Hardy, Robina (AU); Daniel Moore, Molendinar (AU); David G. Rosenbaum, Highland Park, IL (US); Benjamin D. Rotman, Deerfield, IL (US)

(21) Appl. No.: 15/268,404

(22) Filed: Sep. 16, 2016

Related U.S. Application Data
(60) Provisional application No. 62/219,655, filed on Sep. 16, 2015.
(60) Provisional application No. 62/297,934, filed on Feb. 21, 2016.

(51) Int. Cl. H04N 1/44; G06T 3/00; G06F 21/62; G09G 5/397; G06T 11/00; G09G 5/377; G06T 7/00

(52) U.S. Cl. CPC H04N 1/4493; G09G 5/377; G06T 3/0093; G06T 7/0002; G09G 5/397; G06T 11/001; G06F 21/6245; G09G 2358/00; G09G 2340/12; G06T 2207/20212

(57) ABSTRACT

A system and method for analyzing and rendering captured images and/or manipulating pixels to disrupt the capture process and/or captured images from a screen display thereby rendering all or part of the captured images not readily recognizable to a viewer.

### CROSS-REFERENCE TO RELATED APPLICATIONS

This application claims priority to co-pending U.S. Provisional Application No. 62/219,655 filed Sep. 16, 2015 and to co-pending U.S. Provisional Application No. 62/297,934 filed Feb. 21, 2016, each of which are incorporated herein by reference in their entireties.

### BACKGROUND OF THE INVENTION

The present invention relates generally to a system and method for preventing capture of viewable or usable images on mobile devices. More particularly, the present invention works to disrupt the process of taking a screen capture on a mobile device and or actively distort images that have been created via a screen capture.

With the advent of smartphone mobile devices, users are easily and readily able to communicate text and graphical images via the Internet and over cellular data networks. Mobile device applications, known in the art as “apps,” allow users to readily take photographic images using device cameras and transmit these images to other users by text, email, or through a multitude of social media networks, such as FACEBOOK, TWITTER, INSTAGRAM, SNAPCHAT or the like. Several apps have been designed to display a received image for a delimited period of time, then delete the received image from the user's screen and from mobile device memory and/or storage. However, during this delimited period of time, the user receiving the image is able to execute a screenshot and image capture the received image to the mobile device storage and/or memory without the knowledge of the image sender. This ability to execute a screenshot and image capture has resulted in a proliferation of undesired photographic images being circulated over the Internet and on social media without the knowledge and/or consent of the person or persons in the photographic image.

One approach to preventing screenshot image capture is to disable or defeat the keyboard entries that activate a screenshot. Typically, however, mobile device manufactures will not authorize an app for their mobile device operating systems that defeat or disables the hardware functions of the mobile device. This leaves open, however the possibility of manipulating or processing the captured image in such a way as to render it unusable, unviewable or uncopiable as the original image.

Various systems and methods are known to provide copy protection from photographic or video capture devices, such as mobile devices. For example, U.S. Patent Application, Publication No. US 2015/0009248, discloses a copy protection system in which a plurality of frames are displayed at a threshold refresh rate such that they appear as the actual image when viewed by a user, but when captured by an image capture device, it appears as an altered or different image. This reference relies upon the ability of the human eye to perceive an image based upon plural frames of an image displayed at the threshold refresh rate and the capture of by an image capture device of a single frame because of the shutter speed of the image capture device. Using this principal, the reference employs a copy protection component that generates the image as a plural frames where each of the frames differs in some respect from the original image input to the copy protection component. The copy protection component may use color separation techniques to generate the plural frames, such that each frame has pixels having a different color value. Additionally, the copy prevention component may employ facial recognition analysis of the original image to indemnify human faces within the original image, then insert a watermark or other graphic to obscure the human faces within the original image. The watermark would change position within the image such that when the watermarked frames are displayed at the threshold refresh rate, the human faces are visible to the human eye, but when an image capture device takes a picture of the displayed frames, it would capture an image of a single frame with the human faces obscured by the watermark or other graphic. Alternatively, the copy prevention component could be configured to apply Floyd-Steinberg dithering in order to diffuse error into adjacent pixels or subsequent pixels in the display. Similarly, the copy prevention component could be configured to apply temporal dithering together with a moving watermark or graphic based upon facial recognition analysis. The system of this reference is a network that includes a data communication network between a camera device and the copy prevention system, where the copy prevention system previews the processed image on a display device.

Another method of degrading a photographic image on a digital camera is to introduce a source of electromagnetic interference and generate electromagnetic waves of a frequency sufficient to interfere with the functioning of at least one electronic component of the digital camera. U.S. Published Application No. US 2010/0323608 teaches degrading a photographic image being taken by a digital camera by interfering with the taking of the image by the electronic component in the digital camera.

Heretofore, there is no known mobile device application that upon activation of a screen capture routine on the mobile device, that processes an original image captured by the mobile device to render unusable and unviewable by the human eye the original image both on the mobile device display and on any stored versions of the original image on the mobile device.

### SUMMARY OF THE INVENTION

It is, therefore, an objective of the present invention to provide a system and method for blocking the screen capture of an original image displayed on a mobile device display such that the original image is neither viewable by a human eye nor usable from the mobile device memory or storage.

It is another objective of the present invention to provide a system and method that senses initiation of a screen capture routine in a mobile device and processes the captured original image to render it unviewable on the mobile device display by a human eye and unusable from the mobile device memory or storage.

It is still another objective of the present invention to monitor a main loop or process loop of a mobile device and upon sensing activation of a screenshot routine, substitute all or a portion of an image to be captured, with a secondary image, with an altered portion of the original image or by redirecting the captured image to the mobile device's delete cache, also known as the mobile devise “trash bin.”

It is yet another objective of the present invention to provide a system and method in which a refresh rate of the mobile device screen display is increased or decreased when a screenshot routine is detected.

It is still yet another objective of the present invention to set a default state of an original image to be unreadable with static content. A continuous touch/interaction event between the user and the mobile device would be required to remove the static content and render the image readable. In order to execute the screenshot event, the user is required to disrupt the continuous touch/interaction with the mobile device, thereby reintroducing the static content and rendering the image unreadable.

It is yet another objective of the present invention to deploy paid messages or advertising over the static content and renders the static content unreadable when the user disrupts the continuous touch/interaction with the mobile device, and when the user continuously touches or interacts with the mobile device, the paid messages or advertising is removed from the static content and renders it viewable.

It is still yet a further objective of the present invention to provide a plurality of graphic strata that may identify sensitive information within an original image and alter the original image on a frame by frame basis. Image processing software may be used to process and filter the original image adding sensitive information graphic strata that may be used to identify sensitive material and map the pixels of the sensitive information accordingly. Examples of such sensitive information that may be mapped in a sensitive information graphic strata include faces, identifying tattoos, sensitive body parts, such as breasts, nipples or genitals, or locational information such as signs, landmarks or any other potentially sensitive identifying information. Once such identifying and sensitive information is identified in the image, the pixel mapping associated with the sensitive information graphic strata is noted, a distorting graphic strata may be applied in the pixel mapped area of the sensitive information graphic strata to alter or distort the pixel mapped portions. The distorting graphic strata may include but not be limited to blurring layers, color shifting layers, distortion layers, or image overlays to the mapped pixels containing the potentially sensitive information on the individual frames. The image overlays may be patterns and/or text that are either static or dynamic in the manipulated image.

Another objective of the present invention is to create a system and method by which pixels in a source image are selected, then the selected pixels are manipulated to alter the pixel values associated with each of the selected pixels, then a number of copies of the source image are made and the manipulated pixels are replicated in each of the copies such that a number of copies of the modified source image are generated. The copies of the modified source image are then arrayed and mapped as textures. These textures are then processed by the graphical processor pipeline and may be mapped onto basic objects, which may then be run through filters, such as for example, vertex and fragment shaders to make further changes to the modified image, the resulting textures are then mapped to a display screen with one array object per screen refresh.

Another objective of the present invention is to randomly weight a first section of pixels in an image frame and manipulate those first section of pixels to render that first section unreadable, then process a second section of pixels in a second frame in a similar manner, then process a third section of pixels in a third frame, and so on, until a sufficient number of weighted pixel sections have been manipulated and rendered unreadable on a frame by frame basis, such that at the viewing refresh rate, the resulting net image of the plural frames is readable by a human eye. Further a blank frame may be introduced every X sequence of frames. Depending upon the refresh rate, X will be in integer of at least 3.

An alternative objective of the present invention is to divide the original image into plural sections based upon the refresh rate, such as in a grid pattern or as in overlapping circular or other predefined areas having different coordinates on the original image. The system would then manipulate the image in one of the plural sections per frame until each frame had at least one manipulated section rendering that section unreadable.

It is to be understood by a person of skill in the art that the term “graphic strata” refers to either (i) one or more graphic layers embedded within an image file and/or (ii) metadata layers that may include information pertaining to the image file including but not limited to facial or body part recognition data, location data, or other identifying data.

It is to be understood by a person of skill in the art that the term “camera roll” as used in this specification may refer to the image gallery app installed on a mobile device, or the file storage location on a mobile device.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 displays sequential image frames D1-D5 displayed on a mobile screen display and illustrating manipulation of an original image to render it readable on the mobile device screen display, and upon a screen capture of the manipulated image rendering it unreadable on a displayed screen capture image and on the screen captured image saved on the mobile device.

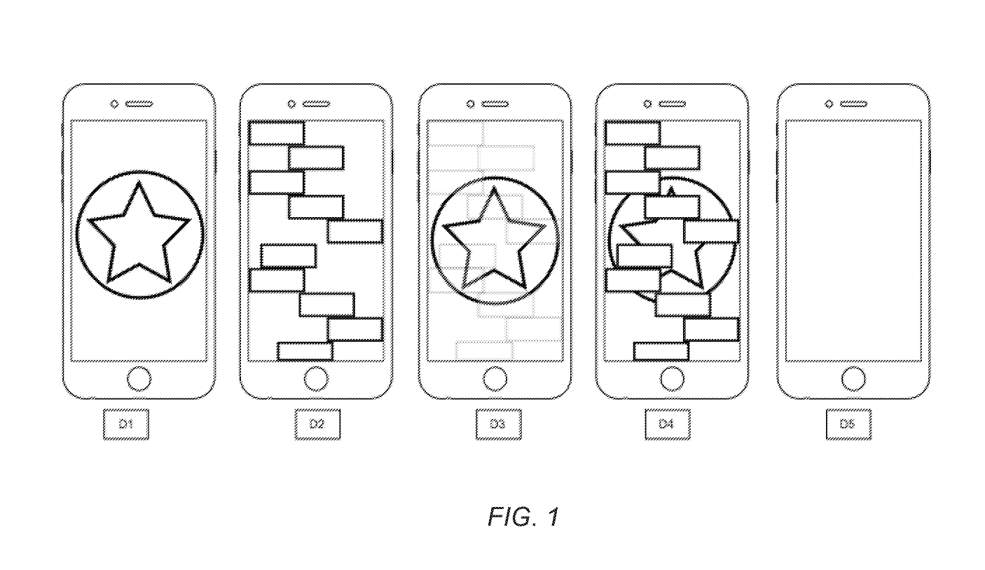

FIG. 2 illustrates alternative embodiments of graphic strata that may be manipulated into or onto an original image to render the manipulated original image readable when viewed on the mobile device screen display, but when a screen capture image is taken, the graphic strata will obscure the original image both on the screen display of the captured image and on the screen captured image saved on the mobile device.

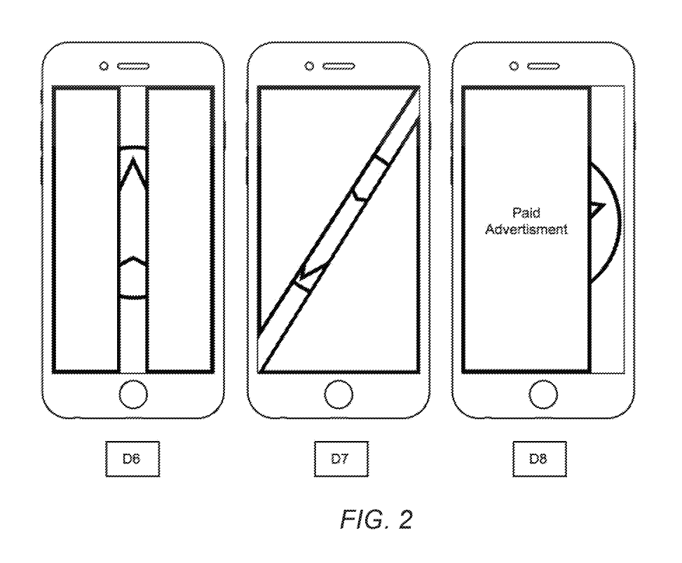

### DETAILED DESCRIPTION OF THE PREFERRED EMBODIMENTS

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Certain mobile devices have a default manufacturer's configuration that prevents the disabling of certain functions on the mobile device. For example, the Apple IPHONE operating system does not permit disabling of the screen capture function (home button+power button combination) either by software or software modification. Thus, it has been found desirable to intervene with the usability of a screen captured image displayed on a user's mobile device. By intervening with the readability and usability of a screen captured image, the user may retain the image on her mobile device, but to disable the mobile user's her ability to use the image, such as by saving it, transferring it by email, text message or other communication method to another mobile device or user, or by downloading or uploading the image to another mobile or computing device.

The present invention, therefore, disables the user's ability to use the image by disrupting the screen captured image. Such disruption of the screen capture image may be accomplished by several different methods, each of which is in accordance with the present invention.

### Image Substitution

In accordance with the image substitution embodiment, the system listens to the main loop or separate process loop on a mobile device and, when a screen capture process is called, it calls a pre-determined image source and interrupts the save routine of the screen capture process, substituting the called image source image to the save routine to the camera roll. The main loop is a top level control flow construct of an event-driven program that waits for, receives and acts or dispatches on the program's input events. It works by making a request to some internal or external event provider which typically blocks the request until an event has arrived, then it calls the relevant event handler to dispatch the event. The steps of this method for rendering a screenshot captured on a mobile device unreadable include monitoring a process loop on the mobile device for screenshot capture instructions. The process loop may be the main loop or any loop that includes the screenshot capture instructions. Upon actuation of the screenshot capture instructions, the method further includes interfering with viewability of a screenshot captured image by substituting a second image for the screenshot captured image and saving a modified captured image from the screenshot capture instructions.

### Image Deletion

Maximum interference with a screen capture occurs as a result of automatically deleting the captured image from the camera roll. Much like the SNAPCHAT model, in which the transmitted image disappears after a predetermined period of time, the image deletion embodiment of the present invention involves the immediate deletion of the last added image to the camera roll on a mobile device. An occurrence of a screenshot is determined by watching for an incrementing of the total number of images on a camera roll and, when it increased by one during the time the application program is operating, the added image is automatically deleted. The steps of this method for rendering a screenshot captured on a mobile device unreadable include monitoring a process loop on the mobile device for screenshot capture instructions. The process loop may be the main loop or any loop that includes the screenshot capture instructions. Upon actuation of the screenshot capture instructions, the method further includes interfering with viewability of a screenshot captured image by deleting the screenshot captured image.

### Visual Overlay Embodiment

In accordance with the visual overlay embodiment method and system of interfering with a screen capture function on a mobile device, an image that has been screen captured on a mobile device is at least partially obscured by a secondary image overlay interposed in the foreground of the screen captured image. The method generally comprises the steps of monitoring an operating system of the mobile device for at least one instruction indicative of a screen capture routine to capture a primary screen capture image. The next step includes overlaying a secondary image onto a foreground of at least a portion of a screen display of the mobile device such that the primary screen capture image is in a background of the screen display. In an optional version of the embodiment, the secondary image is moved about the foreground of at least a portion of the screen display at a rate that visually obscures the primary screen capture image in the background.

In any of the visual overlay embodiments, the secondary image overlay may be a static or dynamic image, that is, it may be static in the sense that it is a fixed image placed in a certain position over the background screen captured image. Alternatively, the secondary image overlay may be dynamic in the sense that either the image is a fixed image and is moved to different screen coordinates over the background screen capture image, such as by horizontal or vertical sweeping across at least a portion of the mobile device display screen. The dynamic image may, alternatively, itself be a series of rotating static images or single or plural video images that are either in a static position or are dynamically movable about the mobile device display screen. Additionally the secondary image may be selected from plurality of images, or may be an advertisement. In this manner, the background screen captured image is obscured to the viewer as well as obscured in another screen captured image of the mobile device screen display.

In some embodiments, the overlay may consist of a plurality of distorting graphic strata that alter the original image on a frame by frame basis. In some embodiments, image processing software may be used to process and filter the original image adding sensitive information graphic strata that may be used to identify sensitive material and map the pixels of the sensitive information accordingly. Examples of such sensitive information that may be mapped in sensitive information graphic strata include faces, identifying tattoos, sensitive body parts, such as breasts, nipples or genitals, or locational information such as signs, landmarks or any other potentially sensitive identifying information. Once such identifying and sensitive information is identified in the image, the pixel mapping associated with the sensitive information graphic strata is noted, a distorting graphic strata may be applied in the pixel mapped area of the sensitive information graphic strata to alter or distort the pixel mapped portions. The distorting graphic strata may include but not be limited to blurring layers, color shifting layers, distortion layers, or image overlays to the mapped pixels containing the potentially sensitive information on the individual frames. The image overlays may be text or patterns that are either static or dynamic in the manipulated image.

In another embodiment, the overlay may consist of a paid messages or advertising that is displayed over the static content or underlying image and renders the static content or underlying image unviewable when the user disrupts continuous touch and/or interaction with the mobile device. When the user continuously touches and/or interacts with the mobile device, the paid messages or advertising is removed from the static content or image and renders it viewable.

A system for manipulating screen captured images on a mobile device, as described above, may comprise a first instruction monitoring activity or inactivity of a screen capture state on a mobile device. The system may additionally comprise a second instruction responsive to activation of the screen capture state on the mobile device that generates a third instruction to manipulate an original image captured by the active screen capture state rendering the original image captured by the active screen capture state unreadable on a screen display of the mobile device and unreadable and unusable on storage or memory of the mobile device. In an additional embodiment of the system, the third instruction introduces distorting graphic strata as described above. In yet another embodiment, the graphic strata is either static or dynamic as described above. In yet another embodiment an additional instruction scans the original image and maps the original image or creates sensitive information strata based on sensitive information that is recognized.

### Variable Refresh Rate Embodiment

The variable refresh rate embodiment method for rendering a screenshot captured image on a mobile device unreadable involves the advantageous use of the difference between the screen capture rate of capture, analogous to shutter speed on a camera, and the refresh rate for the mobile device screen display. The steps of this method include monitoring a process loop on the mobile device for screenshot capture instructions. The process loop may be the main loop or any loop that includes the screenshot capture instructions. Upon actuation of the screenshot capture instructions, the method further includes interfering with viewability of a screenshot captured image by one of (i) changing a refresh rate of a display on the mobile device from a first native refresh rate to a second refresh rate before saving the screenshot captured image at the second refresh rate, (ii) applying a screenshot capture rate that is different than the first native refresh rate; and saving a modified captured image from the screenshot capture instructions.

For example, where the mobile device screen display native refresh rate is 60 frames per second (“fps”), the screen display appears static to the average person. However, the image is actually being continuously updated at the refresh rate of 60 fps. Where the screen capture rate of capture is faster than 60 fps, only one individual frame of the image will be captured in an image capture. However, where the screen capture rate of capture is slower than 60 fps, at least one and perhaps two or more frames will be captured in the image capture. For example, if the screen capture is at 30 fps or one-half the native refresh rate, two frames will be captured. Thus, by taking advantage of differential screen refresh rates and screen capture rates, together with manipulating a foreground image overlaying the background screen captured image, the captured screen will only capture the background screen capture in part or obscured by the overlaid foreground image. Further rendering the screen capture on the mobile device unreadable.

As an alternate, when a screenshot instruction is sent, the program may reducing the native screen refresh rate on the mobile device to a second refresh rate, for example the second refresh rate may be between 10% to 100% lower or higher than the native screen refresh rate, more particularly between 25% to 100% of the native screen refresh rate, and even more particularly between 50% to 100% of the native screen refresh rate. For example, a 100% lower refresh rate would equal a 0 Hz refresh rate, while a 50% refresh rate would equal a 30 Hz refresh rate where the native screen refresh rate is 60 Hz. Conversely, a 100% higher refresh rate will result in a 120 Hz refresh rate for a 60 Hz native refresh rate, thereby effectively capturing two screen images or portions thereof in each single screen capture. Such changes in the native screen refresh rate renders the screen unreadable to a viewer and when the screenshot capture instructions are executed, it images, for example, a 0 Hz or blank frame as the captured image.

### Fractional Image Distortion Embodiment

Each frame of a screen captured image is subjected to image recognition and only a portion of each frame corresponding to a result of the image recognition is displayed to the mobile device user, the sum of all manipulated frames equaling the original screen capture image is seen by the user at the default native refresh rate. In this manner, a screen capture takes an image of one or two manipulated frames.

In accordance with this embodiment of the invention, portions of an image that contain what may be personally sensitive or identifying information, such as faces, tattoos, breasts, nipples or genitalia, are recognized by the program and at least those areas of the captured image are manipulated such as by pixilation, image distortion, overlaying a secondary image over the regions of the primary screen capture image containing the personally sensitive or identifying information, blurring or defocusing, or otherwise obscuring the viewability of those areas of the primary image.

For example, where there is a 100×100 pixel image size and the refresh rate is 60 Hz, plural sections each of for example 10×10, 20×20, 10×20, 30×30 pixels, etc. may be randomly or sequentially manipulated on each frame. In this manner the screen display of the manipulated original image will be viewable by the user, but a screen capture of the manipulated original taken at a shutter speed of 1/60 second or faster will only capture one manipulated frame that is rendered unreadable and unusable as a result of the manipulation of a given pixel second of the captured frame.

### Pixel Manipulation Embodiment

As an alternate embodiment, a captured original image may be passed to an image analyzer and pre-specified points of interest will be identified and selected by the image analyzer. As with the Fractional Distortion Embodiment discussed above, the pre-specified points of interest may be sensitive, confidential or identifying information, such as financial information, body part recognition, location or environmental information or the like. The image analyzer then creates a data package based upon the pre-determine points of interest in the original image, including data pertaining to the pixel data in the original image corresponding to the pre-determined points of interest. This data package is then passed to an image renderer.

Once the image renderer receives the data package, it checks against user selected options, e.g., only block faces, only block number, only block tattoos, etc., the renderer makes multiple copies of the source image and generates a rendering of each copy based upon the user selected options and the data package and modifies pixels on each frame according to the user selected options and data package. The renderer then outputs the rendered multiple copies to an array. The array of the rendered images is produced and mapped to be textures for use by the graphic processor (GPU). The textures are mapped onto basic objects, which are generally the same size as the original image. These basic objects are, in turn, processed, such as with vertex and fragment shaders to make any further desired changes to the rendered image. The textures are mapped to the screen at a rate of at least one array object per refresh/redraw. For example if the refresh rate is 60 Hz or 60 frames per second, the array objects are mapped to the screen at a rate of 60 times per second.

A system for pixel manipulation and image disruption on a display screen in the manner described above may comprise a digital image capture device capable of generating a digital file corresponding to an original captured digital image, an image analyzer capable of identifying pre-specified points of interest in the original image capture, identifying pixel data corresponding to the pre-specified points of interest and generating a data package of pixel data corresponding to the identified pixel data, an image renderer capable of modifying each pixel on each frame of the original image capture, thereby generating a modified digital image and modified pixel data, and rendering plural copies of the modified image, and an array of the plural copies of the modified image capable of being mapped to be textures for a graphical processor pipeline.

As used herein, the terms “readable,” “readability,” “viewable” or “viewability” are intended to encompass the ability of a human viewing the image to readily discern and understand the original image as manipulated or modified. Similarly, the converse terms “unreadable,” “unreadability,” “unviewable,” or “unviewability” are intended to encompass the inability of a human viewing the image to readily discern and understand the original image as manipulated or modified.

As used herein the term “usable” and its converse term “unusable” are intended to encompass the ability and inability, respectively, of a manipulated or screen captured image to be transmitted electronically and to be readable or viewable by a human receiving the transmitted screen captured image.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method for rendering a screenshot captured image on a mobile device unreadable, comprising the steps of:
a. Monitoring a process loop on the mobile device for screenshot capture instructions;
b. Interfering with viewability of a screenshot captured image by one of (i) changing a refresh rate of a display on the mobile device from a first native refresh rate to a second refresh rate before saving the screenshot captured image at the second refresh rate, (ii) applying a screenshot capture rate that is different than the first native refresh rate, (iii) deleting the screenshot captured image or (iv) substituting a second image for the screenshot captured image; and
c. saving a modified captured image from the screenshot capture instructions.

2. The method of claim 1, wherein the step of changing a refresh rate further comprises the step of reducing the first native refresh rate between 10% to 100%.

3. The method of claim 2, were the step of reducing the refresh rate further comprises the step of reducing the refresh rate to 0 Hz.

4. The method of claim 1, wherein the step of changing a refresh rate further comprises the step of increasing the first native refresh rate between 10% to 100%.

5. The method of claim 1, wherein the step of monitoring a process loop further comprises the step of monitoring a main loop of an operating system of the mobile device.

6. A method of interfering with a screen capture function on a mobile device, comprising the steps of:
a. Monitoring an operating system of the mobile device for at least one instruction indicative of a screen capture routine to capture a primary screen capture image;
b. Overlaying a secondary image onto a foreground of at least a portion of a screen display of the mobile device such that the primary screen capture image is in a background of the screen display; and
c. Optionally, moving the secondary image about the foreground of at least a portion of the screen display at a rate that visually obscures the primary screen capture image in the background.

7. The method of claim 6, further comprising the step of selecting the secondary image from a plurality of images.

8. The method of claim 7, wherein the selected secondary image is an advertisement.

9. A system for manipulating screen captured images on a mobile device, comprising:
a. a first instruction monitoring activity or inactivity of a screen capture state on a mobile device; and
b. a second instruction responsive to activation of the screen capture state on the mobile device that generates a third instruction to manipulate an original image captured by the active screen capture state rendering the original image captured by the active screen capture state unreadable on a screen display of the mobile device and unreadable and unusable on storage or memory of the mobile device.

10. The system of claim 9, wherein the third instruction introduces graphic strata onto or into the manipulated original image.

11. The system of claim 10, wherein the graphic strata is selected from the group consisting of blurring, distortion, color shift, text or patterns.

12. The system of claim 11, wherein the graphic strata is static in the manipulated original image.

13. The system of claim 11, wherein the graphic strata is dynamic in the manipulated original image.

14. The system of claim 10 wherein an additional instruction scans the original image captured and maps the original image or creates sensitive information strata based on sensitive information that is recognized by the scan and wherein the third instruction introduces graphic strata onto or into the sensitive information strata.

15. The system of claim 14, wherein the graphic strata is selected from the group consisting of blurring, distortion, color shift, text or patterns.

16. The system of claim 15, wherein the graphic strata is static in the manipulated original image.

17. The system of claim 16, wherein the graphic strata is dynamic in the manipulated original image.

18. A system for pixel manipulation and image disruption on a display screen, comprising:
a. A digital image capture device capable of generating a digital file corresponding to an original image capture;
b. An image analyzer capable of identifying pre-specified points of interest in the original image capture, identifying pixel data corresponding to the pre-specified points of interest and generating a data package corresponding to the identified pixel data;
c. An image renderer capable of modifying each pixel on each frame of the original image capture, thereby generating a modified image, and rendering plural copies of the modified image; and
d. An array of the plural copies of the modified image capable of being mapped to be textures for a graphical processor pipeline.

19. The system of claim 18 wherein the pre-specified points of interest include at least one of the following: confidential or identifying information, financial information, a body part, location or environmental information.

20. A method of image disruption on a display screen, comprising the steps of:
a. capturing a digital image and generating a digital file corresponding to the captured digital image;
b. identifying points of interest in the captured digital image corresponding to parts of the captured digital image to be manipulated;
c. creating a data package of pixel data corresponding to the parts of the captured digital image to be manipulated;
d. modifying the pixel data in the data package;
e. rendering multiple copies of the captured digital image with the modified pixel data to form a modified digital image;
f. generating an array of the multiple copies of the modified digital image; and
g. mapping the array to textures for use by a graphical processor.
